(19) United States
(12) Patent Application Publication
(10) Pub. No.: US 2024/0412547 A1
(43) Pub. Date: Dec. 12, 2024

(54) LAYOUT ANALYSIS SYSTEM, LAYOUT ANALYSIS METHOD, AND PROGRAM

(71) Applicant: RAKUTEN GROUP, INC., Tokyo (JP)

(72) Inventors: Yuzhi SHI, Setagaya-ku, Tokyo (JP); Mijung KIM, Setagaya-ku, Tokyo (JP); Yeongnam CHAE, Setagaya-ku, Tokyo (JP)

(21) Appl. No.: 18/696,991

(22) PCT Filed: Aug. 30, 2022
(86) PCT No.: PCT/JP2022/032644

§ 371 Date: Mar. 28, 2024

(51) Int. Cl. G06V 30/412; G06V 30/414

(52) U.S. Cl. CPC G06V 30/412; G06V 30/414

(57) ABSTRACT

A layout analysis system, comprising at least one processor configured to: detect a cell of each of a plurality of scales from in a document image showing a document including a plurality of components; acquire cell information relating to the cell of each of the plurality of scales; and analyze a layout relating to the document based on the cell information on each of the plurality of scales.

### TECHNICAL FIELD

The present disclosure relates to a layout analysis system, a layout analysis method, and a program.

### BACKGROUND ART

Hitherto, there has been investigated a technology of analyzing a layout of a document based on a document image showing a document having a predetermined layout. For example, in Non Patent Literature 1 to Non Patent Literature 4, there are disclosed technologies of analyzing the layout of a document based on a learning model which has learned the layouts of various types of documents and the coordinates of cells (bounding boxes) including components of the document shown in a document image.

### CITATION LIST

### Non Patent Literature

[NPL 1] Yupan Huang, Tengchao Lv, Lei Cui, Yutong Lu, Furu Wei, “LayoutLMv3: Pre-training for Document AI with Unified Text and Image Masking,” https://arxiv.org/abs/2204.08387, ACM Multimedia 2022
[NPL 2] “Doc-former,” Internet, retrieved on Aug. 15, 2022, online, https://github.com/shabie/docformer
[NPL 3] Peizhao Li, Jiuxiang Gu, Jason Kuen, Vlad I. Morariu, Handong Zhao, Rajiv Jain, Varun Manjunatha, Hongfu Liu, “SelfDoc: Self-Supervised Document Representation Learning,” https://arxiv.org/abs/2106.03331, CVPR2021
[NPL 4] Anonymous, “ERNIE-Layout: Layout-Knowledge Enhanced Multi-modal Pre-training for Document Understanding,” https://openreview.net/pdf?id=NHECrvMz1LL

### SUMMARY OF INVENTION

### Technical Problem

However, in the technologies as disclosed in Non Patent Literature 1 to Non Patent Literature 4, the layout is analyzed by detecting only the cells of a certain one scale, and thus it has not been possible to sufficiently improve the accuracy of layout analysis. For example, when only a word level in which a word is the unit of the cells is used, it is difficult to analyze large features like tokens in which consecutive words are the unit of the cells, lines in which rows are the unit of the cells, or text blocks in which blocks of text are the unit of the cells. Conversely, when only the cells of a text block are used, it is difficult to analyze small features.

One object of the present disclosure is to increase an accuracy of layout analysis.

### Solution to Problem

According to one embodiment of the present disclosure, there is provided a layout analysis system including: a cell detection module configured to detect a cell of each of a plurality of scales from in a document image showing a document including a plurality of components; a cell information acquisition module configured to acquire cell information relating to the cell of each of the plurality of scales; and a layout analysis module configured to analyze a layout relating to the document based on the cell information on each of the plurality of scales.

### Advantageous Effects of Invention

According to the present disclosure, the accuracy of the layout analysis is increased.

### BRIEF DESCRIPTION OF DRAWINGS

FIG. 1 is a diagram for illustrating an example of an overall configuration of a layout analysis system.

FIG. 2 is a diagram for illustrating an example of a document image.

FIG. 3 is a diagram for illustrating an example of a document image on which optical character recognition has been executed.

FIG. 4 is a diagram for illustrating an example of functions implemented in a first embodiment of the present disclosure.

FIG. 5 is a diagram for illustrating an example of a relationship between an input and an output of a learning model in the first embodiment.

FIG. 6 is a table for showing an example of cell information.

FIG. 7 is a diagram for illustrating an example of layout analysis in the first embodiment.

FIG. 8 is a diagram for illustrating an example of layout analysis in the first embodiment.

FIG. 9 is a flowchart for illustrating an example of processing executed in the first embodiment.

FIG. 10 is a diagram for illustrating an example of scales in a second embodiment of the present disclosure.

FIG. 11 is a diagram for illustrating an example of functions implemented in the second embodiment.

FIG. 12 is a diagram for illustrating an example of a relationship between an input and an output of a learning model in the second embodiment.

FIG. 13 is a diagram for illustrating an example of small areas.

FIG. 14 is a diagram for illustrating an example of layout analysis in the second embodiment.

FIG. 15 is a flowchart for illustrating an example of processing executed in the second embodiment.

FIG. 16 is a diagram for illustrating an example of functions in modification examples relating to the first embodiment.

### DESCRIPTION OF EMBODIMENTS

### 1. First Embodiment

Description is now given of a first embodiment of the present disclosure, which is an example of an embodiment of a layout analysis system according to the present disclosure.

### 1-1 Overall Configuration of Layout Analysis System

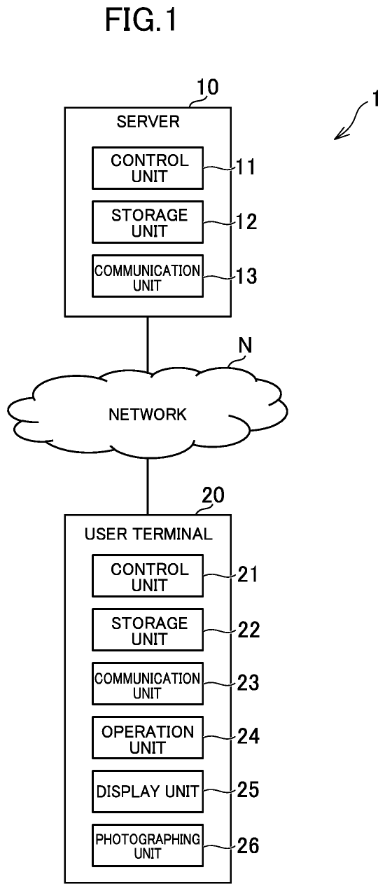

FIG. 1 is a diagram for illustrating an example of an overall configuration of the layout analysis system. For example, a layout analysis system 1 includes a server 10 and a user terminal 20. The server 10 and the user terminal 20 are each connectable to a network N, such as the Internet or a LAN.

The server 10 is a server computer. A control unit 11 includes at least one processor. A storage unit 12 includes a volatile memory such as a RAM, and a nonvolatile memory such as a flash memory. A communication unit 13 includes at least one of a communication interface for wired communication or a communication interface for wireless communication.

The user terminal 20 is a computer of a user. For example, the user terminal 20 is a personal computer, a tablet terminal, a smartphone, or a wearable terminal. The physical configurations of a control unit 21, a storage unit 22, and a communication unit 23 are the same as those of the control unit 11, the storage unit 12, and the communication unit 13, respectively. An operation unit 24 is an input device such as a touch panel or a mouse. A display unit 25 is a liquid crystal display or an organic EL display. A photographing unit 26 includes at least one camera.

The programs stored in the storage units 12 and 22 may be supplied via the network N. Further, each computer may include at least one of a reading unit (for example, a memory card slot) for reading a computer-readable information storage medium or an input/output unit (for example, a USB port) for inputting/outputting data to and from external devices. For example, a program stored in an information storage medium may be supplied via at least one of the reading unit or the input/output unit.

Moreover, it is only required for the layout analysis system 1 to include at least one computer, and is not limited to the example of FIG. 1. For example, the layout analysis system 1 may not include the user terminal 20, and may include only the server 10. In this case, the user terminal 20 exists outside the layout analysis system 1. For example, the layout analysis system 1 may include another computer other than the server 10, and layout analysis may be executed by this another computer.

For example, the another computer is a personal computer, a tablet terminal, or a smartphone.

### 1-2. Overview of First Embodiment

The layout analysis system 1 of the first embodiment analyzes a layout of a document shown in a document image. A document image is an image showing all or a part of a document. A part of the document is shown in at least a part of pixels of the document image. The document image may show only one document or may show a plurality of documents. In the first embodiment, description is given of a case in which the document image is generated by the photographing unit 26 photographing the document, but the document image may also be generated by a scanner reading the document.

A document is a piece of written communication that includes human-understandable information. For example, a document is a sheet of paper on which characters are formed. In the first embodiment, a receipt which a user receives when making a purchase at a store is given as an example of a document, but the layout analysis system 1 is capable of handling various types of documents. For example, the layout analysis system 1 can be applied to various types of documents such as invoices, estimates, applications, official written communication, internal written communication, flyers, academic papers, magazines, newspapers, or reference books.

As used herein, “layout” refers to the arrangement of components in the document. Layout is sometimes referred to as “design.” A component is an element forming the document. A component is information itself formed in the document. For example, a component is a character, a symbol, a logo, a graphic, a photograph, a table, or an illustration. For example, a plurality of patterns relating to layout exist for documents. Each document has one of those plurality of patterns as a layout.

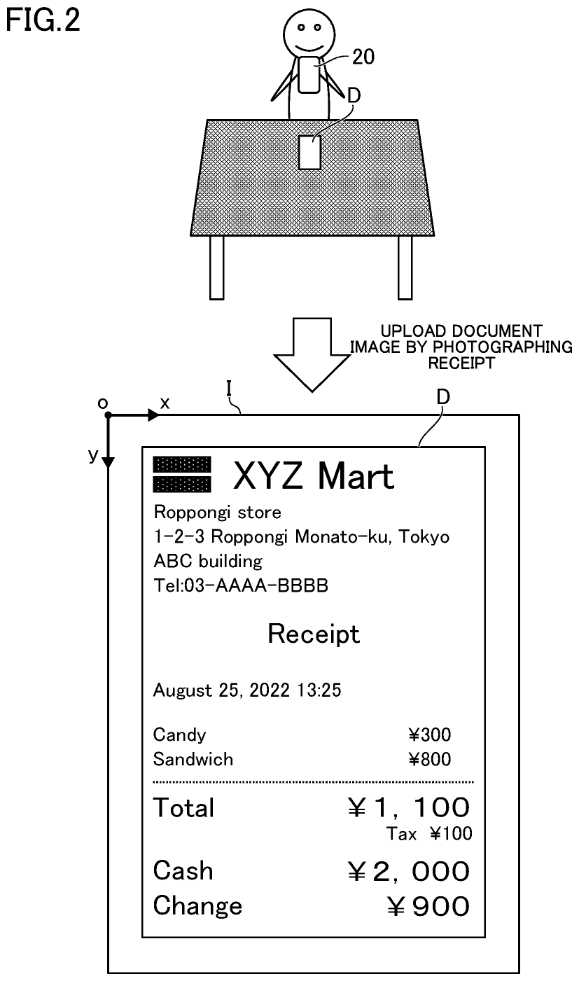

FIG. 2 is a diagram for illustrating an example of a document image. For example, when a user operates the user terminal 20 to photograph a document D, the user terminal 20 generates a document image I in which the document D is shown. In the example of FIG. 2, an x-axis and a y-axis are set with an upper left of the document image I as an origin 0. Positions in the document image I are indicated by two-dimensional coordinates including an x-coordinate and a y-coordinate. Positions in the document image I can be expressed through use of any-coordinate system, and are not limited to the example illustrated in FIG. 2. For example, positions in the document image I may be expressed through use of a coordinate system in which the center of the document image I is the origin 0, or expressed using a polar coordinate system.

For example, the user terminal 20 transmits the document image I to the server 10. The server 10 receives the document image I from the user terminal 20. It is assumed that the server 10 cannot identify the type of layout of the document D which is shown in the document image I at the time the server 10 receives the document image I. The server 10 cannot even identify whether a receipt is shown in the document image I as the document D. In the first embodiment, the server 10 executes optical character recognition on the document image I in order to analyze the layout of the document D.

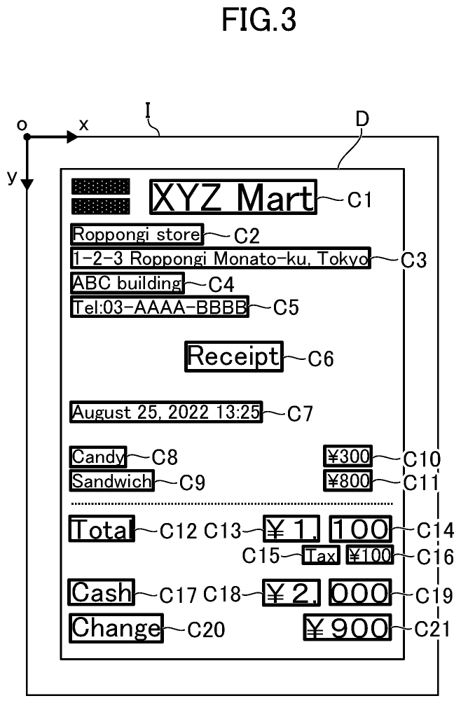

FIG. 3 is a diagram for illustrating an example of a document image I on which optical character recognition has been executed. For example, the server 10 detects cells C1 to C21 from in the document image I by using a publicly-known optical character recognition tool. When the cells C1 to C21 are not distinguished from one another, the cells C1 to C21 are hereinafter simply referred to as “cells C.” The cells C may have any shape, and are not limited to the rectangle shape illustrated in FIG. 3. For example, the cells C may be squares, rounded rectangles, polygons other than a rectangle, or ellipses.

Each cell C is an area which includes a component of the document D. The cells C are sometimes referred to as “bounding boxes.” In the first embodiment, the cells C are detected by using an optical character recognition tool, and thus each cell C includes at least one character. A cell C may be detected for each character, but in the first embodiment, a plurality of consecutive characters are detected as one cell C.

For example, even when a space is arranged between characters, when the space is small to some extent, one cell C including a plurality of words separated by spaces may be detected. In the example of FIG. 3, a space is arranged between “XYZ” and “Mart” in the document D, but instead of the cell C of “XYZ” and the cell C of “Mart” being detected separately, one cell C1 including “XYZ Mart” is detected. Similarly to the cell C1, the cells C2 to C4 and C7 also include a plurality of words separated by spaces.

For example, even when a word is originally a single word that does not include spaces, the word may be recognized as separate words. In the example of FIG. 3, “¥1, 100” in the document D is one word, but the size thereof is larger than those of the other characters, and hence there is a gap between the “¥1,” and the “100.” In the example of FIG. 3, the cell C13 which includes “¥1,” and the cell C14 which includes “100” are detected due to this gap. Similar to the cells C13 and C14, for the cells C18 and C19 as well, a single word which originally does not include a space is recognized as separate words.

For example, the layouts of receipts that exist in the world generally fall into a few types of patterns. Thus, when the document D shown in the document image I is a receipt, the document D often has a layout of one of those types of patterns. With optical character recognition alone, it is difficult to identify whether the characters in the document image I indicate product details or a total amount, but when the layout of the document D can be analyzed, it becomes easier to identify where on the document D the product details or the total amount is printed.

Thus, the server 10 analyzes the layout of the document D based on the arrangement of the cells C detected from the document image I. For example, the server 10 may use a learning model to analyze the layout of the document D by inputting the coordinates of the cells C to the learning model, which has learned various types of layouts. In this case, the learning model converts the pattern of the coordinates of the cells C input to the learning model into a feature amount, and outputs a layout having a pattern close to this pattern among the learned layouts as an estimation result.

However, even when the cells C are arranged in the same row of the document D, the coordinates detected by optical character recognition may differ. In the example of FIG. 3, the cells C8 and C10 are arranged in the same row as each other, but the y-coordinates of the cells C8 and C10 detected by optical character recognition may not be the same. Due to bending or distortion of the document D in the document image I, the y-coordinates of the cells C8 and C10 may differ from each other. For example, due to a slight difference in the y-coordinates of the cells C8 and C10, the learning model may internally recognize those cells to be arranged in different rows. In this case, the accuracy of layout analysis may decrease.

The above-mentioned point is not limited to the rows of the document D, and the same applies to the columns of the document D. In the example of FIG. 3, the cells C10 and C11 are arranged in the same columns as each other, but the x-coordinates of the cells C10 and C11 detected by optical character recognition may not be the same. Due to bending or distortion of the document D in the document image I, the x-coordinates of the cells C10 and C11 may differ from each other. For example, due to a slight difference in the x-coordinates of the cells C10 and C11, the learning model may internally recognize those cells to be arranged in different columns. In this case, the accuracy of layout analysis may decrease.

In view of the above, the layout analysis system 1 of the first embodiment groups the cells C which are in the same row and the same column based on the coordinates of the cells C. The layout analysis system 1 uses the learning model to analyze the layout under a state in which the cells C are grouped in rows and columns, thereby absorbing the above-mentioned slight deviation in coordinates and increasing the accuracy of the layout analysis. Details of the first embodiment are now described.

### 1-3. Functions Implemented in First Embodiment

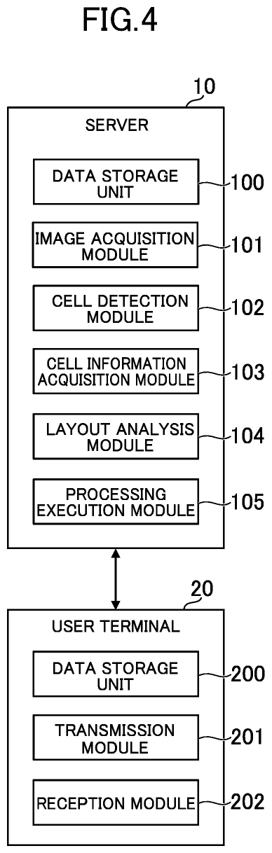

FIG. 4 is a diagram for illustrating an example of functions implemented in the first embodiment.

### 1-3-1. Functions Implemented by Server

A data storage unit 100 is implemented by the storage unit 12. An image acquisition module 101, a cell detection module 102, a cell information acquisition module 103, a layout analysis module 104, and a processing execution module 105 are implemented by the control unit 11.

### [Data Storage Unit]

The data storage unit 100 stores data required for analyzing the layout of the document D. For example, the data storage unit 100 stores a learning model which analyzes the layout of the document D based on the document image I. The learning model is a model which uses a machine learning technology. The data storage unit 100 stores a program and parameters of the learning model. The parameters are adjusted by learning. As the machine learning method, any of supervised learning, semi-supervised learning, and unsupervised learning may be used.

In the first embodiment, a case in which the learning model is a Vision Transformer-based model is given as an example. Vision Transformer is a method which applies Transformer, which is mainly used in natural language processing, to image processing. Transformer analyzes connections in input data in which the components of a document are arranged in chronological order. Vision Transformer divides an input image which has been input to Vision Transformer into a plurality of patches, and acquires input data in which a plurality of patches are arranged. Vision Transformer is a method which uses context analysis by Transformer to analyze connections between patches. Vision Transformer converts each of the patches included in the input data into a vector, and analyzes the vectors. The learning model in the first embodiment uses this Vision Transformer architecture.

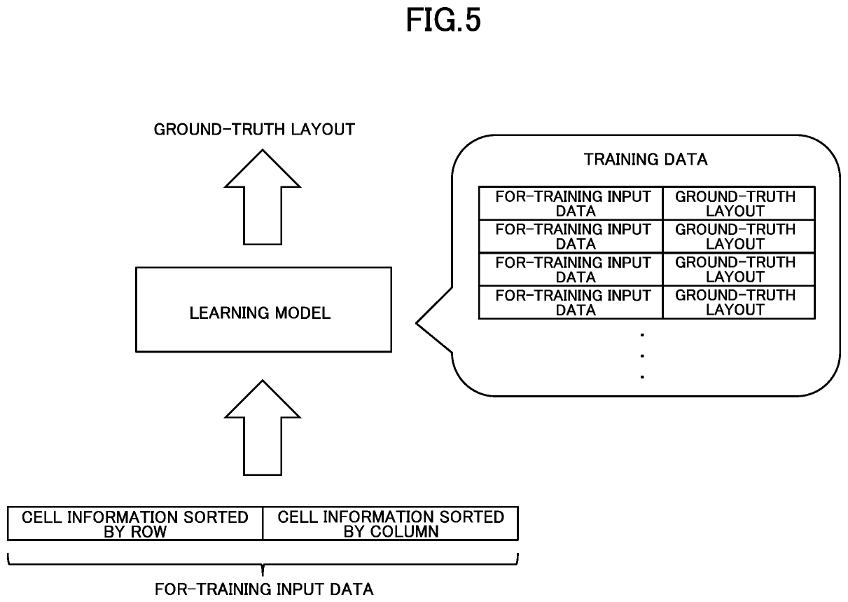

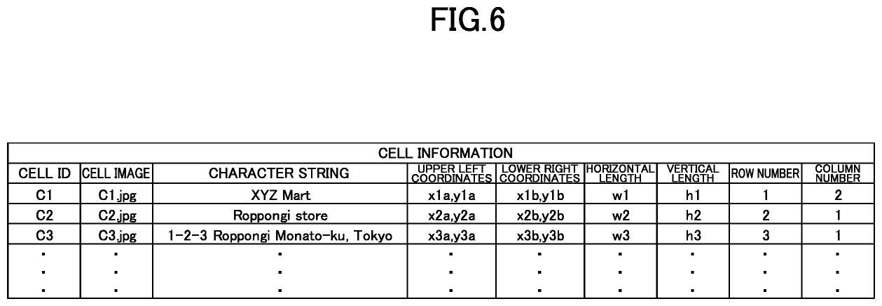

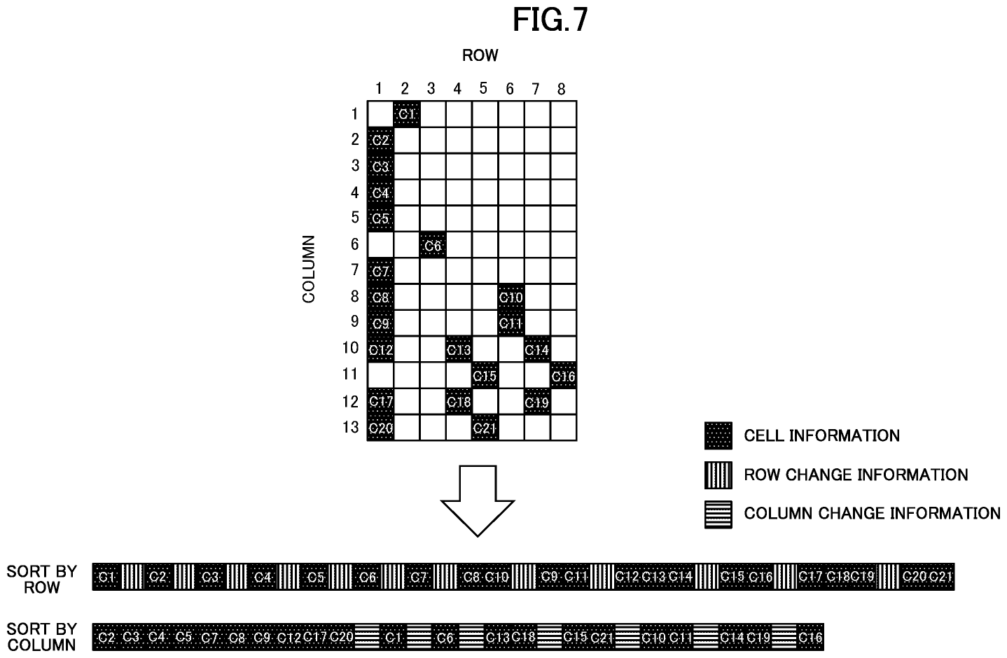

FIG. 5 is a diagram for illustrating an example of a relationship between an input and an output of a learning model in the first embodiment. For example, the data storage unit 100 stores training data of the learning model. The training data shows a relationship between for-training input data and a ground-truth layout. The for-training input data is in the same format as that of the input data input to the learning model during estimation. In the first embodiment, the size of the input data is also determined in advance. As described later with reference to FIG. 6 and FIG. 7, the input data includes cell information sorted by row and cell information sorted by column. Details of the cell information are described later.

As illustrated in FIG. 5, in the for-training input data included in the training data, cell information acquired from a training image showing a for-training document is sorted and arranged by row and by column. For example, the server 10 executes processing similar to that of the cell detection module 102 and cell information acquisition module 103 described later on the training image showing the for-training document, and acquires the cell information on each of the plurality of cells detected from the training image. The server 10 acquires the for-training input data by sorting the cell information on each of the plurality of cells C by row and by column in the training image. The for-training input data also includes row change information and column change information, which are described later. In the first embodiment, the sorted cell information included in the for-training input data corresponds to an image or a vector of each of the patches in Vision Transformer.

For example, the ground-truth layout included in the training data is manually specified by a creator of the learning model. The ground-truth layout is a label of the layout. For example, labels such as “receipt pattern A” and “receipt pattern B” are defined as the ground-truth layout. The server 10 generates a pair of for-training input data and a ground-truth layout as training data. The server 10 generates a plurality of pieces of training data based on a plurality of training images. The server 10 adjusts the parameters of the learning model so that when the for-training input data included in a certain piece of training data is input to the learning model, the ground-truth layout included in the certain piece of training data is output from the learning model.

The learning model can itself be trained by using the method used in Vision Transformer. For example, the server 10 may train the learning model based on Self-Attention, in which connections between the elements included in the input data are learned. Further, the training data may be created by a computer other than the server 10, or may be created manually. The learning model may also be trained by a computer other than the server 10. It suffices that the data storage unit 100 store the trained learning model in some form.

The learning model may be a model which uses a machine learning method other than Vision Transformer. Examples of other machine learning methods which can be used include various methods used in the field of image processing. For example, the learning model may be a model which uses a neural network, a long/short-term memory network, or a support vector machine. The training of the learning model can also be performed by using other methods such as error backpropagation or gradient descent which are used in other machine learning methods.

Further, the data stored in the data storage unit 100 is not limited to the learning model. It suffices that the data storage unit 100 store the data required for layout analysis, and any data can be stored. For example, the data storage unit 100 may store a program for training the learning model, a database storing document images I having a layout to be analyzed, and an optical character recognition tool.

### [Image Acquisition Module]

The image acquisition module 101 acquires a document image I. Acquiring a document image I means acquiring the image data of the document image I. In this embodiment, description is given of a case in which the image acquisition module 101 acquires the document image I from the user terminal 20, but the image acquisition module 101 may acquire the document image I from another computer other than the user terminal 20. For example, when the document image I is recorded in advance in the data storage unit 100 or another information storage medium, the image acquisition module 101 may acquire the document image I from the data storage unit 100 or the another information storage medium. The image acquisition module 101 may directly acquire the document image I from a camera or a scanner.

The document image I may be a moving image instead of a still image. When the document image I is a moving image, at least one frame included in the moving image may be the layout analysis target. Further, the data format of the document image I may be any format, for example, JPEG, PNG, GIF, MPEG, or PDF.

The document image I is not limited to an image in which a physical document D is captured, and may be an image showing an electronic document D created by the user terminal 20 or another computer. For example, a screenshot of an electronic document D may correspond to the document image I. For example, data in which text information in the electronic document D has been lost may correspond to the document image I.

### [Cell Detection Module]

The cell detection module 102 detects a plurality of cells C from in a document image I showing a document D which includes a plurality of components. In the first embodiment, description is given as an example of a case in which the cell detection module 102 detects a plurality of cells C by executing optical character recognition on the document image I. Optical character recognition is a method of recognizing characters from an image. The optical character recognition tool itself can use various tools, and for example, a tool which uses a matrix matching method that compares with an image serving as a sample, a tool which uses a feature detection method that compares the geometrical characteristics of lines, or a tool which uses a machine learning method may be used.

For example, the cell detection module 102 detects the cells C from in the document image I by using the optical character recognition tool. The optical character recognition tool recognizes characters in the document image I, and outputs various types of information relating to the cells C based on the recognized characters. In the first embodiment, the optical character recognition tool outputs, for each cell C, the image in the cell C of the document image I, at least one character included in the cell C, the upper left coordinates of the cell C, the lower right coordinates of the cell C, the horizontal length of the cell C, and the vertical length of the cell C. The cell detection module 102 detects the cells C by acquiring the outputs from the optical character recognition tool.

It suffices that the optical character recognition tool output at least some sort of coordinates of the cells C, and the information output by the optical character recognition tool is not limited to the above-mentioned example. For example, the optical character recognition tool may output only the upper left coordinates of the cells C. In the case of identifying the positions of the cells C by using coordinates other than the upper left coordinates of the cells C, the optical character recognition tool may output other coordinates. The cell detection module 102 may detect the cells C by acquiring the other coordinates output from the optical character recognition tool. For example, the other coordinates may be the coordinates of the center point of the cells C, the upper right coordinates of the cells C, the lower left coordinates of the cell C, or the lower right coordinates of the cells C.

Further, the cell detection module 102 may detect the cells C from in the document image I by using a method other than optical character recognition. For example, the cell detection module 102 may detect the cells C from in the document image I based on Scene Text Detection which detects text included in a scene, an object detection method which detects areas having a high physicality such as characters, or a pattern matching method which compares with an image serving as a sample. In those methods, some sort of coordinates of the cells C are also output.

### [Cell Information Acquisition Module]

The cell information acquisition module 103 acquires cell information relating to at least one of the row or the column of each of the plurality of cells C based on the coordinates of each of the plurality of cells C. As used herein, “row” refers to the line of cells C in the y-axis direction of the document image I. Each row is a group of cells C having the same or a close y-coordinate. A close y-coordinate means that the distance in the y-axis direction is less than a threshold value. As used herein, “column” is a line of cells C in the x-axis direction of the document image I. Each column is a group of cells C having the same or a close x-coordinate. A close x-coordinate means that the distance in the x-axis direction is less than a threshold value.

For example, the cell information acquisition module 103 identifies the cells C that are in the same row and the cells C that are in the same column based on the coordinates of each of the plurality of cells C. The rows and the columns can also be referred to as information which represents the position in the document image I more roughly than the coordinates. In the first embodiment, description is given of an example in which the cell information is information relating to both the row and the column of the cell C, but the cell information may be information relating to only the row of the cell C, or information relating to only the column of the cell C. That is, the cell information acquisition module 103 may identify the cells C which are in the same row as each other and not the cells C that are in the same column as each other. Conversely, the cell information acquisition module 103 may identify the cells C which are in the same column as each other and not the cells C which are in the same row as each other.

FIG. 6 is a table for showing an example of cell information. In the example of FIG. 6, cell information is shown in a table format. Each record in the table of FIG. 6 corresponds to a piece of cell information. For example, the cell information includes a cell ID, a cell image, a character string, upper left coordinates, lower right coordinates, a horizontal length, a vertical length, a row number, and a column number. It suffices that the cell information include at least one of the row number or the column number, and is not limited to the example shown in FIG. 6. For example, the cell information may include only at least one of the row number or the column number. It suffices that the cell information include some sort of feature of the cell C.

It is acceptable that the cell information not include a part of the items shown in FIG. 6, and the cell information may include other items. For example, the cell image and the character string may each be included in the cell information in the form of a feature amount called an embedded representation. A method called convolution may be used to calculate the embedded representation of the cell image. Various methods such as fastText or Word2vec can be used to calculate the embedded representation of the character string.

The cell ID is information that can uniquely identify a cell C. For example, the cell ID is issued in consecutive numbers starting from 1 in a certain document image I. The cell ID may be issued by the optical character recognition tool, or may be issued by the cell detection module 102 or the cell information acquisition module 103. The cell image is an image in which the inside of the cell C is cut out from the document image I. The character string is the result of character recognition by optical character recognition. In the first embodiment, the cell ID, the cell image, the character string, the upper left coordinates, the lower right coordinates, the horizontal length, and the vertical length are output from the optical character recognition tool.

The row number is the order of the row in the document image I. In the first embodiment, the row numbers are assigned in order from the top of the document image I, but the row numbers may be assigned based on a rule determined in advance. For example, the row numbers may be assigned in order from the bottom of the document image I. Cells C having the same row number belong to the same row. The row to which a cell C belongs may be identified based on other information such as characters instead of the row number.

The column number is the order of the column in the document image I. In the first embodiment, the column numbers are assigned in order from the left of the document image I, but the column numbers may be assigned based on a rule determined in advance. For example, the column numbers may be assigned in order from the right of the document image I. Cells C having the same column number belong to the same column. The column to which a cell C belongs may be identified based on other information such as characters instead of the column number.

In the first embodiment, the cell information acquisition module 103 acquires the cell information relating to the row of each of the plurality of cells C based on the y-coordinate of each of the plurality of cells C so that the cells C having a distance from each other in the y-axis direction of less than a threshold value are arranged in the same row. For example, the cell information acquisition module 103 calculates the distance between the upper left y-coordinate of each of the plurality of cells C and the upper left y-coordinate of another cell C, and when the calculated distance is less than the threshold value, determines that those cells C are in the same row and assigns the same row number to those cells C. When the calculated distance is equal to or more than the threshold value, the cell information acquisition module 103 determines that those cells C are in different rows, and assigns different row numbers to those cells C. In the first embodiment, the threshold value for identifying the same row is a fixed value determined in advance. For example, the threshold value for identifying the same row is set to be the same as or smaller than the vertical length of a standard font of the document D.

In the example of FIG. 3, among the cells C1 to C21, the cell having the smallest upper left y-coordinate is the cell C1. The cell information acquisition module 103 calculates the distance between the upper left y-coordinate of the cell C1 and the upper left y-coordinate of the cell C2, which has the second smallest upper left y-coordinate, and determines whether or not the calculated distance is less than the threshold value. The cell information acquisition module 103 determines that the distance is equal to or more than the threshold value, and determines that only the cell C1 belongs to the first row. The cell information acquisition module 103 assigns to the cell C1 the row number “1” indicating that the cell C1 is in the first row.

For example, the cell information acquisition module 103 calculates the distance between the upper left y-coordinate of the cell C2, which has the second smallest upper left y-coordinate, and the upper left y-coordinate of the cell C3, which has the third smallest upper left y-coordinate, and determines whether or not the calculated distance is less than the threshold value. The cell information acquisition module 103 determines that the distance is equal to or more than the threshold value, and determines that only the cell C2 belongs to the second row. The cell information acquisition module 103 assigns to the cell C2 the row number “2” indicating that the cell C2 is in the second row. Thereafter, in the same manner, the cell information acquisition module 103 assigns to the cells C3 to C7 the row numbers “3” to “7” indicating that those cells are in the third to seventh rows, respectively.

For example, the cell information acquisition module 103 calculates the distance between the upper left y-coordinate of the cell C8, which has the eighth smallest upper left y-coordinate, and the upper left y-coordinate of the cell C10, which has the ninth smallest upper left y-coordinate, and determines whether or not the calculated distance is less than the threshold value. The cell information acquisition module 103 determines that the distance is less than the threshold value. The cell information acquisition module 103 calculates the distance between the upper left y-coordinate of the cell C8, which has the eighth smallest upper left y-coordinate, and the upper left y-coordinate of the cell C9, which has the tenth smallest upper left y-coordinate, and determines whether or not the calculated distance is less than the threshold value. The cell information acquisition module 103 determines that the distance is equal to or more than the threshold value, and determines that the cells C8 and C10 belong to the eighth row and that the cell C9 does not belong to the eighth row. The cell information acquisition module 103 assigns to the cells C8 and C10 the row number “8” indicating that the cells C8 and C10 are in the eighth row.

Thereafter, in the same manner, the cell information acquisition module 103 assigns to the cells C9 and C11 the row number “9” indicating that those cells are in the ninth row. The cell information acquisition module 103 assigns to the cells C12, C13, and C14 the row number “10” indicating that those cells are in the tenth row. The cell information acquisition module 103 assigns to the cells C15 and C16 the row number “11” indicating that those cells are in the eleventh row. The cell information acquisition module 103 assigns to the cells C17, C18, and C19 the row number “12” indicating that those cells are in the twelfth row. The cell information acquisition module 103 assigns to the cells C20 and C21 the row number “13” indicating that those cells are in the thirteenth row.

In the first embodiment, the cell information acquisition module 103 acquires the cell information relating to the column of each of the plurality of cells C based on the x-coordinate of each of the plurality of cells C so that the cells C having a distance from each other in the x-axis direction of less than a threshold value are arranged in the same column. For example, the cell information acquisition module 103 calculates the distance between the upper left x-coordinate of each of the plurality of cells C and the upper left x-coordinate of another cell C, and when the calculated distance is less than the threshold value, determines that those cells C are in the same column and assigns the same column number to those cells C. When the calculated distance is equal to or more than the threshold value, the cell information acquisition module 103 determines that those cells C are in different columns, and assigns different column numbers to those cells C. In the first embodiment, the threshold value for identifying the same column is a fixed value determined in advance. For example, the threshold value for identifying the same column is set to be the same as or smaller than the horizontal length of one character of a standard font of the document D.

In the example of FIG. 3, among the cells C1 to C21, the cell having the smallest upper left x-coordinate is the cell C2. The cell information acquisition module 103 calculates the distance between the upper left x-coordinate of the cell C2 and the upper left x-coordinate of the cell C3, which has the second smallest upper left x-coordinate, and determines whether or not the calculated distance is less than the threshold value. The cell information acquisition module 103 determines that the distance is less than the threshold value. Thereafter, in the same manner, the cell information acquisition module 103 calculates the distance between the upper left x-coordinate of the cell C2 and the upper left x-coordinate of each of the cells C4, C5, C7, C8, C9, C12, C17, and C20, which have the third to tenth smallest upper left x-coordinates, respectively, and determines that each of those distances is less than the threshold value. The cell information acquisition module 103 determines that the cells C2, C3, C4, C5, C7, C8, C9, C12, C17, and C20 belong to the first column. The cell information acquisition module 103 assigns to the cells C2, C3, C4, C5, C7, C8, C9, C12, C17, and C20 the column number “1” indicating that those cells are in the first column.

Thereafter, in the same manner, the cell information acquisition module 103 assigns to the cell C1 the column number “2” indicating that the cell C1 is in the second column. The cell information acquisition module 103 assigns to the cell C6 the column number “3” indicating that the cell C6 is in the third column. The cell information acquisition module 103 assigns to the cells C13 and C18 the column number “4” indicating that those cells are in the fourth column. The cell information acquisition module 103 assigns to the cells C15 and C21 the column number “5” indicating that those cells are in the fifth column. The cell information acquisition module 103 assigns to the cells C10 and C11 the column number “6” indicating that those cells are in the sixth column. The cell information acquisition module 103 assigns to the cells C14 and C19 the column number “7” indicating that those cells are in the seventh column. The cell information acquisition module 103 assigns to the cell C16 the column number “8” indicating that the cell C16 is in the eighth column.

In the first embodiment, description is given of a case in which the cell information acquisition module 103 identifies the cells C belonging to the same row or column based on the upper left coordinates of the cell C, but the cells C belonging to the same row or column may be identified based on the upper right coordinates, the lower left coordinates, the lower right coordinates, or internal coordinates of the cells C. In this case as well, the cell information acquisition module 103 may determine whether or not the cells C belong to the same row or column based on the distance between the plurality of cells C.

### [Layout Analysis Module]

The layout analysis module 104 analyzes the layout relating to the document D based on the cell information on each of the plurality of cells C. For example, the layout analysis module 104 analyzes the layout of the document D based on at least one of the column number or the row number indicated by the cell information. In the first embodiment, description is given of a case in which the layout analysis module 104 analyzes the layout of the document D based on both the column number and the row number indicated by the cell information, but the layout analysis module 104 may analyze the layout of the document D based on only one of the column number or the row number indicated by the cell information.

In this embodiment, the layout analysis module 104 analyzes the layout based on a learning model in which for-training layouts relating to for-training documents have been learned. The learning model has learned the relationships between for-training cell information and the for-training layouts. The layout analysis module 104 inputs the cell information on each of the plurality of cells C to the learning model. The learning model converts the cell information on each of the plurality of cells C into a feature amount, and outputs the layout corresponding to the feature amount. A feature amount is also referred to as “embedded representation.” In the first embodiment, description is given of a case in which the feature amount is expressed in a vector form, but the feature amount may be expressed in another form such as an array or a single numerical value. The layout analysis module 104 analyzes the layout by acquiring the layout output from the learning model.

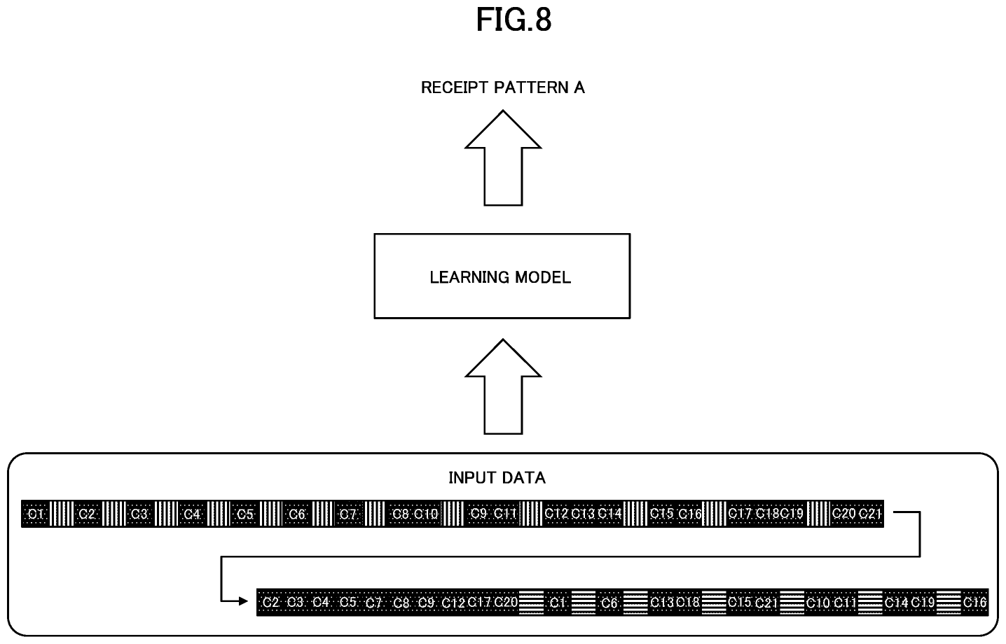

FIG. 7 and FIG. 8 are diagrams for illustrating an example of layout analysis in the first embodiment. The row and column matrix in FIG. 7 indicates the rows and columns to which the cells C1 to C21 belong. The sizes of the cells C1 to C21 are different from one another, but in the matrix of FIG. 7, the cells are shown as having the same size. In the first embodiment, the learning model is a Vision Transformer-based model, and thus the layout analysis module 104 analyzes the layout by arranging the cell information on each of the plurality of cells C under predetermined conditions, inputting the arranged cell information to the learning model, and acquiring the result of layout analysis by the learning model. For example, the cell information includes the order of the row in the document image I, and hence the layout analysis module 104 sorts the cell information on each of the plurality of cells C based on the row order of each of the plurality of cells C, and inputs the sorted cell information to the learning model.

In the examples of FIG. 7 and FIG. 8, the layout analysis module 104 sorts the cell information in ascending order of row number. Thus, the layout analysis module 104 sorts the cell information so that the cell information is arranged in order starting from the first row. For example, the layout analysis module 104 arranges the cell information in order of the cells C1, C2, C3, C4, C5, C6, C7, C8, C10, C9, C11, C12, C13, C14, C15, C16, C17, C18, C19, C20, and C21. Cells C having the same row number are sorted in order of cell ID. The layout analysis module 104 may sort the cell information in descending order of row number. Input data which includes the cell information sorted by row is input to the learning model.

In the first embodiment, the layout analysis module 104 sorts the cell information on each of the plurality of cells C based on the row order of each of the plurality of cells C, inserts predetermined row change information into a portion which has a row change, and inputs the cell information having the inserted predetermined row change information to the learning model. Row change information is information that can identify that the row has changed. For example, a specific character string indicating that the row has changed corresponds to the row change information. The row change information is not limited to a character string, and may be a single character indicating that the row has changed, or an image indicating that the row has changed. Through insertion of the row change information, the learning model can identify the portions in the series of time-series data input to the learning model which have a row change.

In the examples of FIG. 7 and FIG. 8, the layout analysis module 104 inserts the row change information between cells C1 and C2, between cells C2 and C3, between cells C3 and C4, between cells C4 and C5, between cells C5 and C6, between cells C6 and C7, between cells C7 and C8, between cells C10 and C9, between cells C11 and C12, between cells C14 and C15, between cells C16 and C17, and between cells C19 and C20. In FIG. 7, the row change information is indicated by a square having vertical lines. Each piece of row change information may be the same as each other, or may include information indicating a boundary between the rows.

For example, the cell information includes the order of the column in the document image I, and hence the layout analysis module 104 sorts the cell information on each of the plurality of cells C based on the column order of each of the plurality of cells C, and inputs the sorted cell information to the learning model. In the examples of FIG. 7 and FIG. 8, the layout analysis module 104 sorts the cell information in ascending order of column number. Thus, the layout analysis module 104 sorts the cell information so that the cell information is arranged in order starting from the first column. For example, the layout analysis module 104 arranges the cell information in order of the cells C2, C3, C4, C5, C7, C8, C9, C12, C17, C20, C1, C6, C13, C18, C15, C21, C10, C11, C14, C19, and C16. Cells C having the same column number are sorted in order of cell ID. The layout analysis module 104 may sort the cell information in descending order of column number. Input data which includes the cell information sorted by column is input to the learning model.

In the first embodiment, the layout analysis module 104 sorts the cell information on each of the plurality of cells C based on the column order of each of the plurality of cells C, inserts predetermined column change information into portions in which the column changes, and inputs the cell information having the inserted predetermined column change information to the learning model. Column change information is information that can identify that the column has changed. For example, a specific character string indicating that the column has changed corresponds to the column change information. The column change information is not limited to a character string, and may be a single character indicating that the column has changed, or an image indicating that the column has changed. Through insertion of the column change information, the learning model can identify the portions in the series of time-series data input to the learning model which have a column change.

In the examples of FIG. 7 and FIG. 8, the layout analysis module 104 inserts the column change information between cells C20 and C1, between cells C1 and C6, between cells C6 and C13, between cells C18 and C15, between cells C21 and C10, between cells C11 and C14, and between cells C19 and C16. In FIG. 7, the column change information is indicated by a square having horizontal lines. Each piece of column change information may be the same as each other, or may include information indicating a boundary between the columns.

As illustrated in FIG. 8, the layout analysis module 104 inputs, to the learning model, input data in which the cell information sorted by column is arranged after the cell information sorted by row. Between the cell information sorted by row and the cell information sorted by column, information indicating that there is a boundary between those pieces of cell information may be arranged. Further, the layout analysis module 104 may input, to the learning model, input data in which the cell information sorted by row is arranged after the cell information sorted by column. In this case, between the cell information sorted by column and the cell information sorted by row, information indicating that there is a boundary between those pieces of cell information may be arranged.

As illustrated in FIG. 8, through arrangement of the cell information under predetermined conditions, the input data becomes data that has a chronological meaning. The conditions for sorting the cell information are not limited to the row number and the column number. For example, the cell information may be sorted in the order of the cell ID or in the order of the upper left coordinates. Even when sorting is performed in such a manner, the cell information includes the row number and column number, and thus the learning model can execute the layout analysis by taking into account the rows and the columns of the cells C.

The learning model converts the input data into a feature amount, and outputs the layout corresponding to the feature amount. In the calculation of the feature amount, the arrangement of the cell information (connections between pieces of cell information) in the input data is also taken into account. In the example of FIG. 8, the learning model outputs information indicating to which of the plurality of patterns learned by the learning model the layout belongs. For example, when the arrangement of the cell information in the input data included in the training data learned by the learning model is similar to the arrangement of the cell information in the input data input to the learning model, the learning model outputs the ground-truth layout which is included in the training data.

In the first embodiment, description is given of a case in which cell information including each of the items of FIG. 6 (cell ID, cell image or embedded representation thereof, character string or embedded representation thereof, upper left coordinates, lower right coordinates, horizontal length, vertical length, row number, and column number) is arranged, but cell information which includes only a part of the items of FIG. 6 may be arranged. For example, input data in which cell information including only the cell image or embedded representation thereof and the character string or embedded representation thereof is sorted by row number or column number may be input to the learning model. It suffices that the cell information include the items considered to be effective in layout analysis.

When another machine learning method other than Vision Transformer is used, the layout analysis module 104 may input the cell information as data in a format which can be input to the learning model of the another machine learning method. Further, in a case in which the size of the input data is determined in advance, when the size of all the cell information is insufficient for the size of the input data, padding may be inserted to make up for the insufficient portion. In this case, the size of the whole input data is adjusted through padding to a predetermined size. Similarly, the training data of the learning model may be adjusted to a predetermined size through padding.

### [Processing Execution Module]

The processing execution module 105 executes predetermined processing based on the result of layout analysis. The predetermined processing is processing which corresponds to the purpose of analyzing the layout. In the first embodiment, description is given of a case in which processing of acquiring product details and a total amount corresponds to the predetermined processing. The processing execution module 105 identifies, based on the result of layout analysis, the positions in the document D in which the product details and the total amount are written. The processing execution module 105 acquires the product details and the total amount based on the identified positions.

In the example of FIG. 3, the product details are often written after the cell C6 arranged near the center in the x-axis direction, and thus the processing execution module 105 identifies the cells C8 to C11 as the product details. The total amount is often written below the product details, and thus the processing execution module 105 identifies the cells C12 to C14 as the total amount. The processing execution module 105 identifies the product details and the total amount, and transmits the identified product details and total amount to the user terminal 20. Through such processing, the product details and the total amount can be automatically identified from the document image I, thereby increasing convenience for the user. The user can use the product details and the total amount in household accounting software, for example.

The predetermined processing executed by the processing execution module 105 is not limited to the above-mentioned example. It suffices that the predetermined processing be processing which corresponds to the purpose of using the layout analysis system 1. For example, the predetermined processing may be processing of outputting the layout analyzed by the layout analysis module 104, processing of outputting only the cells C corresponding to the layout from among all the cells C, or processing of manipulating the document image I in some manner corresponding to the layout.

### 1-3-2. Functions Implemented by User Terminal

A data storage unit 200 is mainly implemented by the storage unit 22. A transmission module 201 and a reception module 202 are mainly implemented by the control unit 21.

### [Data Storage Unit]

The data storage unit 200 stores data required for acquiring the document image I. For example, the data storage unit 200 stores a document image I generated by the photographing unit 26.

### [Transmission Module]

The transmission module 201 transmits various types of data to the server 10. For example, the transmission module 201 transmits the document image I to the server 10.

### [Reception Module]

The reception module 202 receives various types of data from the server 10. For example, the reception module 202 receives, as a result of layout analysis, product details and a total amount from the server 10.

### 1-4. Processing Executed in First Embodiment

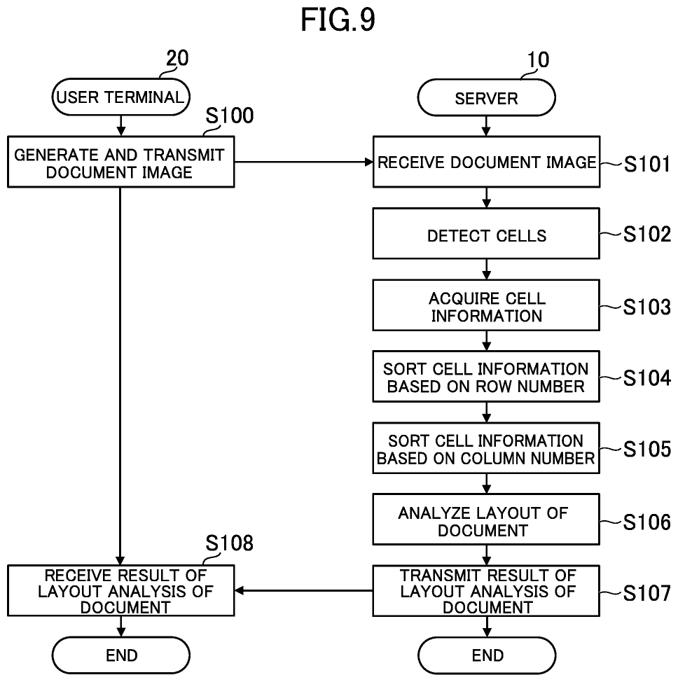

FIG. 9 is a flowchart for illustrating an example of processing executed in the first embodiment. As illustrated in FIG. 9, when the user photographs a document D by using the photographing unit 26, the user terminal 20 generates a document image I, and transmits the generated document image I to the server 10 (Step S100). The server 10 receives the document image I from the user terminal 20 (Step S101). The server 10 executes optical character recognition on the document image I based on the optical character recognition tool, and detects the cells C (Step S102). In Step S102, the server 10 acquires the portions of the cell information on the cells C other than the row number and the column number.

The server 10 acquires the cell information on each of the plurality of cells C by assigning, based on the y-coordinate of each of the plurality of cells C, the same row number to the cells C belonging to the same row, and based on the x-coordinate of each of the plurality of cells C, the same column number to the cells C belonging to the same column (Step S103). In Step S103, the server 10 acquires the portions of the cell information which have not been acquired in the processing step of Step S102.

The server 10 sorts the cell information on the cells C based on the row numbers included in the cell information acquired in Step S103 (Step S104). The server 10 sorts the cell information on the cells C based on the column numbers included in the cell information acquired in Step S103 (Step S105). The server 10 analyzes the layout of the document D based on the cell information sorted in Step S104 and Step S105 and the learning model (Step S106). The server 10 transmits the result of layout analysis of the document D to the user terminal 20 (Step S107). The user terminal 20 receives the result of layout analysis of the document D (Step S108), and this processing is finished.

The layout analysis system 1 of the first embodiment detects a plurality of cells C from in the document image I in which the document D is shown. The layout analysis system 1 acquires the cell information relating to at least one of the row or the column of each of the plurality of cells C based on the coordinates of each of the plurality of cells C. The layout analysis system 1 analyzes the layout relating to the document D based on the cell information on each of the plurality of cells C. As a result, the impact of a slight deviation in the coordinates of the components arranged in the same row or column in the document image I can be absorbed, thereby increasing the accuracy of the layout analysis. For example, even when a certain component A and another component B are originally to be arranged in the same row or column, when a slight deviation between the coordinates of the cells C of the component A and the coordinates of the cells C of the component B causes the component A and the component B to be recognized as being arranged in rows or columns different from each other, the accuracy of the layout analysis may decrease. Regarding this point, the layout analysis system 1 of the first embodiment can analyze the layout after having identified that the components A and B are in the same row or column, and thus the accuracy of the layout analysis is increased.

Further, the layout analysis system 1 analyzes the layout based on a learning model which has learned for-training layouts relating to for-training documents. Through the use of a trained learning model, it becomes possible to handle unknown layouts. For example, when the coordinates of the cells C are input directly to the learning model, there is a possibility that a slight deviation in the coordinates between the cells C in the same row or column causes the cells C to be internally recognized in the learning model as being in different rows or columns. However, by identifying the cells C which are in the same row or column before inputting to the learning model, it is possible to prevent a decrease in the accuracy of layout analysis due to such a deviation in coordinates.

Further, the layout analysis system 1 analyzes the layout by arranging the cell information on each of the plurality of cells C under predetermined conditions, inputting the arranged cell information to the learning model, and acquiring the result of layout analysis by the learning model. Through the use of input data obtained by arranging the cell information, the layout can be analyzed by causing the learning model to take into account a relationship between pieces of cell information, thereby increasing the accuracy of the layout analysis. For example, the learning model can analyze the layout by also taking into account the relationship between the characteristics of a certain cell C and the characteristics of the next arranged cell C.

Further, in the layout analysis system 1, the learning model is a Vision Transformer-based model. Through the use of Vision Transformer which can easily take the relationships among the items included in the input data into account, it becomes easier to take the relationships among the pieces of cell information into account, and the accuracy of the layout analysis is thus increased.

Further, the layout analysis system 1 sorts the cell information on each of the plurality of cells C based on the row order of each of the plurality of cells C, and inputs the sorted cell information to the learning model. As a result, it becomes easier for the learning model to recognize the relationships among the cells C in the same row, thereby increasing the accuracy of the layout analysis.

The layout analysis system 1 also sorts the cell information on each of the plurality of cells based on the row order of each of the plurality of cells C, inserts predetermined row change information into a portion which has a row change, and inputs the cell information having the inserted predetermined row change information to the learning model. This means that the learning model can recognize a portion which has a row change based on the row change information. As a result, the learning model can more easily recognize the relationships among the cells C in the same row, thereby increasing the accuracy of the layout analysis.

Further, the layout analysis system 1 sorts the cell information on each of the plurality of cells C based on the column order of each of the plurality of cells C, and inputs the sorted cell information to the learning model. As a result, the learning model can more easily recognize the relationships among the cells C in the same column, thereby increasing the accuracy of the layout analysis.

The layout analysis system 1 also sorts the cell information on each of the plurality of cells C based on the column order of each of the plurality of cells C, inserts predetermined column change information into portions in which the column changes, and inputs the cell information having the inserted predetermined column change information to the learning model. This means that the learning model can recognize the portions in which the row changes based on the column change information. As a result, the learning model can more easily recognize the relationships among the cells C in the same column, thereby increasing the accuracy of the layout analysis.

Further, the layout analysis system 1 acquires the cell information relating to the row of each of the plurality of cells C based on the y-coordinate of each of the plurality of cells C so that the cells C having a distance from each other in the y-axis direction of less than a threshold value are arranged in the same row. As a result, the cells C which are in the same row can be identified more accurately.

Further, the layout analysis system 1 acquires the cell information relating to the column of each of the plurality of cells C based on the x-coordinate of each of the plurality of cells C so that the cells C having a distance from each other in the x-axis direction of less than a threshold value are arranged in the same column. As a result, the cells C which are in the same column can be identified more accurately.

Further, the layout analysis system 1 detects the plurality of cells C by executing optical character recognition on the document image I. As a result, the accuracy of the layout analysis of the document D including characters is increased.

### 2. Second Embodiment

Description is now given of a second embodiment of the present disclosure, which is another embodiment of the layout analysis system 1. In the second embodiment, a layout analysis system 1 which can handle multiple scales is described. Multiple scales means that the cells C of each of a plurality of scales are detected. A scale is a unit serving as a detection standard for a cell C. A scale can also be said to be a collection of characters included in a cell C.

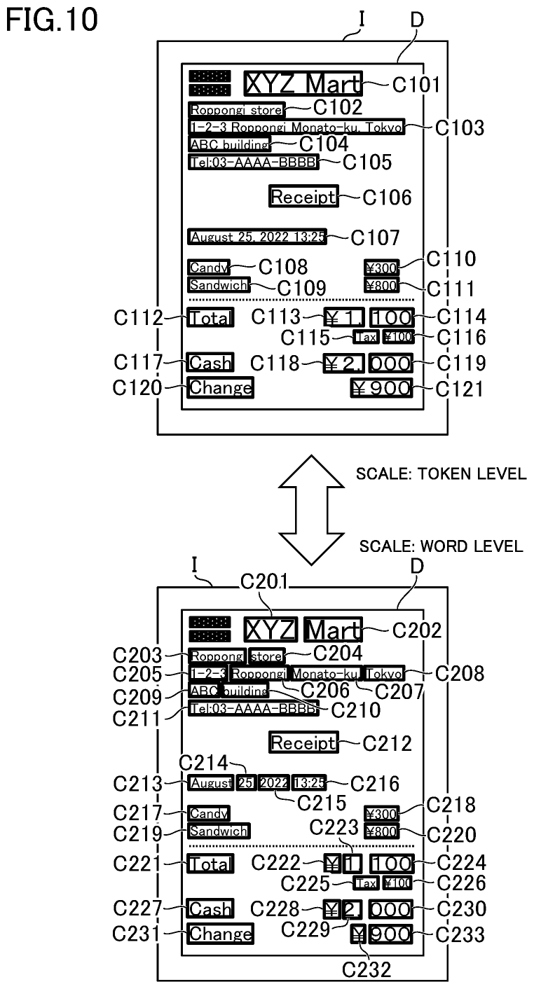

FIG. 10 is a diagram for illustrating an example of scales in the second embodiment. In the second embodiment, as an example of the scales, description is given of two scales, namely, a token level and a word level. In FIG. 10, cells C101 to C121 at the token level and cells C201 to C233 at the word level are illustrated. The cells C101 to C121 are the same as the cells C1 to C21 in the first embodiment. When the cells C101 to C121 and the cells C201 to C233 are not distinguished from one another, the cells C101 to C121 and the cells C201 to C233 are hereinafter simply referred to as “cells C.” The two document images I of FIG. 10 are the same.

The token level is a scale in which a token is the unit of the cells C. A token is a collection of at least one word. A token can also be referred to as a “phrase.” For example, even in a case in which there is a space between a certain word and the next word, when the space is equal to one character, those two words are recognized as one token. The same applies to three or more words. The token-level cells C include one token. However, even when the token is originally one token, a plurality of cells C may be detected from the one token due to a slight space between characters. The scale of the cells C described in the first embodiment is at the token level.

The word level is a scale in which a word is the unit of the cells C. The word-level cells C include one word. When a space exists between a certain character and the next character, words are separated by the space between those characters. Similarly to the token level, even when the word is originally one word, a plurality of cells C may be detected from the one word due to a slight space between the characters. The words included in the document D may belong to the token-level cells C or to the word-level cells C.

The scales themselves may be any level, and are not limited to the token level and the word level. For example, the scales may be a document level in which the whole document is the unit of the cells C, a text block level in which a text block is the unit of the cells C, or a line level in which a line is the unit of the cells C. When only one document D is shown in the document image I, only one document-level cell C is detected from the document image I. A text block is a collection of a certain amount of text, such as a paragraph. When the document D is written horizontally, a line has the same meaning as a row, and when the document D is written vertically, a line has the same meaning as a column.

In the second embodiment, input data including cell information on the cells C101 to C121 at the token level and cell information on the cells C201 to C233 at the word level is input to the learning model. The layout analysis system 1 analyzes the layout of the document D based on the cell information on the cells C of each of the plurality of scales instead of based on the cells C of a certain single scale. The layout analysis system 1 increases the accuracy of the layout analysis by performing integrated analysis based on a plurality of scales. Details of the second embodiment are now described. In the second embodiment, descriptions of like parts to those in the first embodiment are omitted.

### 2-1. Functions Implemented in Second Embodiment

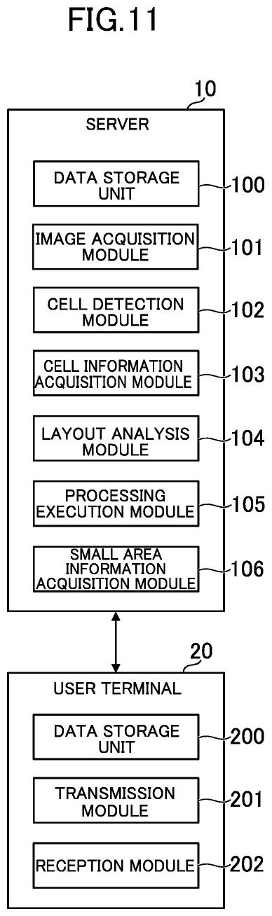

FIG. 11 is a diagram for illustrating an example of functions implemented in the second embodiment.

### 2-1-1. Functions Implemented by Server

For example, a data storage unit 100, an image acquisition module 101, a cell detection module 102, a cell information acquisition module 103, a layout analysis module 104, a processing execution module 105, and a small area information acquisition module 106 are included. The small area information acquisition module 106 is implemented by the control unit 11.

### [Data Storage Unit]

The data storage unit 100 is generally the same as in the first embodiment. The data storage unit 100 in the second embodiment stores an optical character recognition tool corresponding to each of a plurality of scales. In the second embodiment, the plurality of scales include a token level in which a token including a plurality of words is the unit of the cells C, and a word level in which a word is the unit of the cells C. Thus, the data storage unit stores an optical character recognition tool which detects the cells C at the token level and an optical character recognition tool which detects the cells C at the word level. Those optical character recognition tools are not required to be separated in a plurality of optical character recognition tools, and one optical character recognition tool may be used for the plurality of scales.

In the second embodiment, only the word-level optical character recognition tool may be used. In this case, the token-level cells C may be detected by grouping the word-level cells C. For example, the cell detection module 102 may group adjacent cells C in the same row among the word-level cells C, and detect the grouped cells C as one token-level cell C. Similarly, the cell detection module 102 may group adjacent cells C in the same column among the word-level cells C, and detect the grouped cells C as one token-level cell C. In this way, the cell detection module 102 may detect the cells C of another scale by grouping the cells C of a certain scale.

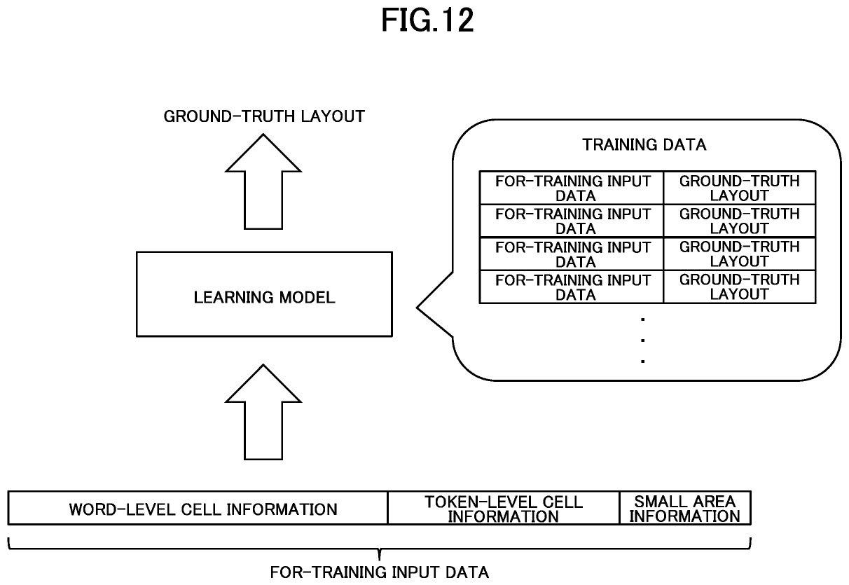

FIG. 12 is a diagram for illustrating an example of a relationship between an input and an output of a learning model in the second embodiment. The training data in the second embodiment includes token-level cell information, word-level cell information, and small area information. The token-level cell information includes cell information sorted by row and cell information sorted by column. Among the training data in the second embodiment, a portion of the token-level cell information is the same as the training data in the first embodiment described with reference to FIG. 5.

The word-level cell information of FIG. 12 differs from the token-level cell information in that the word-level cell information is at the word level, but is the same in other respects. Thus, in the training data in the second embodiment, a portion of the word-level cell information is arranged such that cell information sorted by row is followed by cell information sorted by column. The word-level cell information may be arranged such that cell information sorted by column is followed by cell information sorted by row. The small area information is information relating to a small area in which the training image is divided into a plurality of portions. Details of the small area information are described later.

In the second embodiment, the size of the input data for the learning model is determined in advance. Further, the size of each of the word-level cell information, the token-level cell information, and the small area information in the input data is also determined in advance. For example, in the whole input data, “a” (“a” is any positive number; for example, a=100) pieces of information are arranged. In the word level portion, “b” (“b” is a positive number smaller than “a” and larger than “c”, which is described later; for example, b=50) pieces of information are arranged. In the token level portion, “c” (“c” is a positive number smaller than “b”; for example, c=30) pieces of information are arranged. In the small area information portion, a-b-c (for example, 20) pieces of information are arranged.

The input data may be defined by having a predetermined number of bits instead of being defined by the number of pieces of information. For example, in the whole input data, “d” (“d” is any positive number; for example, d=1,000) bits of information are arranged. In the word level portion, “e” (“e” is a positive number smaller than “d” and larger than “f”, which is described later; for example, b=500) bits of information are arranged. In the token level portion, “f” (“f” is a positive number smaller than “e”; for example, f=300) bits of information are arranged. In the small area information portion, d-e-f (for example, 200) bits of information may be arranged.

### [Image Acquisition Module]

The image acquisition module 101 is the same as in the first embodiment.

### [Cell Detection Module]

The basic processing itself by which the cell detection module 102 detects the cells C is the same as in the first embodiment, but the second embodiment differs from the first embodiment in that the cell detection module 102 can handle multiple scales. The cell detection module 102 detects the cells C of each of a plurality of scales from a document image I in which a document D including a plurality of components is shown. For example, the cell detection module 102 detects, based on a token-level optical character recognition tool, a plurality of token-level cells C from in the document image I such that one token is included in one cell C. The method of detecting the token-level cells C is the same as described in the first embodiment.

For example, the cell detection module 102 detects, based on a word-level optical character recognition tool, a plurality of word-level cells C from in the document image I such that one word is included in one cell C. This differs from the detection of the token-level cells C in that word-level cells C are detected, but is similar in other respects. The word-level morphological analysis tool outputs, for each cell C which includes a word, the cell image, the word included in the cell C, the upper left coordinates of the cell C, the lower right coordinates of the cell C, the horizontal length of the cell C, and the vertical length of the cell C. The cell detection module 102 detects the word-level cells C by acquiring the outputs from the optical character recognition tool.

Depending on the components of the document D, the cell detection module 102 may detect the cells C of each of the plurality of scales such that at least one of a plurality of components is included in a cell C having a different scale from the other cells C. In the example of FIG. 10, a component “XYZ” is included in the token-level cell C100 and also in the word-level cell C200. Other components may similarly be included in both of a token-level cell C and a word-level cell C.

When one optical character recognition tool handles both the token level and the word level, the cell detection module 102 may acquire, from the one optical character recognition tool, the outputs relating to the token-level cells C and the outputs relating to the word-level cells C. When another scale other than the token level and the word level is used, the cell detection module 102 may detect the cells C of the another scale.

For example, when a document-level scale is used, the cell detection module 102 detects cells C indicating the whole document D. In this case, instead of using an optical character recognition tool, the cell detection module 102 may detect the document-level cells C based on contour extraction processing of extracting a contour of the document D. For example, when a text-block-level scale is used, the cell detection module 102 may detect the text-block-level cells C by acquiring the outputs from an optical character recognition tool which handles the text block level. For example, when a line-level scale is used, the cell detection module 102 may detect the line-level cells C by acquiring the outputs from an optical character recognition tool which handles the line level.

### [Cell Information Acquisition Module]

The method by which the cell information acquisition module 103 acquires the cell information is the same as in the first embodiment, but in the second embodiment, the cell information acquisition module 103 acquires the cell information relating to the cells C of each of a plurality of scales. The items themselves included in the cell information may be the same as those in the first embodiment. In the second embodiment, the cell information may include information which can identify each of the plurality of scales. In the second embodiment, like in the first embodiment, the cell information acquisition module 103 identifies the row number and the column number of each cell C, and includes the identified row number and column number in the cell information.

In the second embodiment, the cell information acquisition module 103 acquires, from among a plurality of scales, the cell information for a scale in which a plurality of words is the unit of the cells C based on any one of the plurality of words. For example, the token-level cells C may include a plurality of words. The cell information acquisition module 103 may include information on the plurality of words included in the token in the cell information, but it is assumed here that the cell information acquisition module 103 includes only the first word among the plurality of words in the cell information. The cell information acquisition module 103 may include only the second or subsequent word in the cell information instead of the first word among the plurality of words.

### [Small Area Information Acquisition Module]

The small area information acquisition module 106 divides the document image I into a plurality of small areas based on division positions determined in advance, and acquires small area information relating to each of the plurality of small areas. Each division position is a position indicating a boundary of the small areas. Each small area is an area of a part of the document image I. In the second embodiment, description is given of an example in which all the small areas have the same size, but the sizes of the small areas may be different from each other.

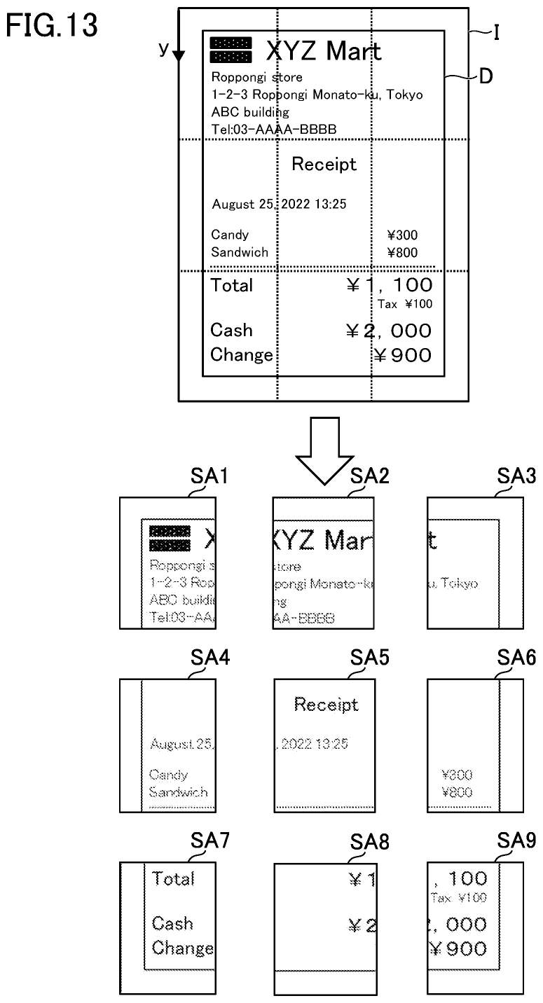

FIG. 13 is a diagram for illustrating an example of small areas. In FIG. 13, the division positions are indicated on the document image I by broken lines. For example, the small area information acquisition module 106 divides the document image I into nine 3×3 small areas SA1 to SA9 by dividing the document image I into three equal parts in each of the x-axis direction and the y-axis direction. When the small areas SA1 to SA9 are not distinguished from one another, the small areas SA1 to SA9 are hereinafter simply referred to as “small areas SA.” The small area information acquisition module 106 acquires, for each small area SA, the small area information relating to the small area SA.

In the second embodiment, the items included in the small area information are the same as the items included in the cell information, but the items included in the small area information and the items included in the cell information may be different from each other. For example, the small area information includes a small area ID, a small area image, a character string, upper left coordinates, lower right coordinates, a horizontal length, a vertical length, a row number, and a column number. The small area ID is information that can identify the small area SA. The small area image is a portion of the document image I in the small area SA. The character string is at least one character included in the small area SA. Characters in the small area SA are acquired by optical character recognition. Similarly to the cell information, the small area image and characters included in the small area information may be converted into a feature amount.

The division positions for acquiring the small areas SA are determined in advance, and thus the upper left coordinates, the lower right coordinates, the horizontal length, the vertical length, the row number, and the column number are values determined in advance. The number of small areas SA may be any number, and is not limited to nine as illustrated in FIG. 13. For example, the small area information acquisition module 106 may divide into 2 to 8 or 10 or more small areas SA. When there are 2 to 8 or 10 or more small areas SA, similarly, it suffices that the small area information acquisition module 106 acquire the small area information for each small area SA.

### [Layout Analysis Module]

The layout analysis module 104 analyzes the layout relating to the document D based on the cell information on each of the plurality of scales. In the second embodiment, the layout analysis module 104 analyzes the layout based on a learning model in which for-training layouts relating to for-training documents D have been learned. Like in the first embodiment, a Vision Transformer-based model is described as an example of the learning model.

The learning model has learned the relationship between the cell information on each of the plurality of scales acquired for training and the for-training layouts. The layout analysis module 104 inputs the cell information on each of the plurality of scales to the learning model. The learning model converts the cell information on each of the plurality of scales into a feature amount, and outputs the layout corresponding to the feature amount. The details of the feature amount are as described in the first embodiment. The layout analysis module 104 analyzes the layout by acquiring the layout output from the learning model.

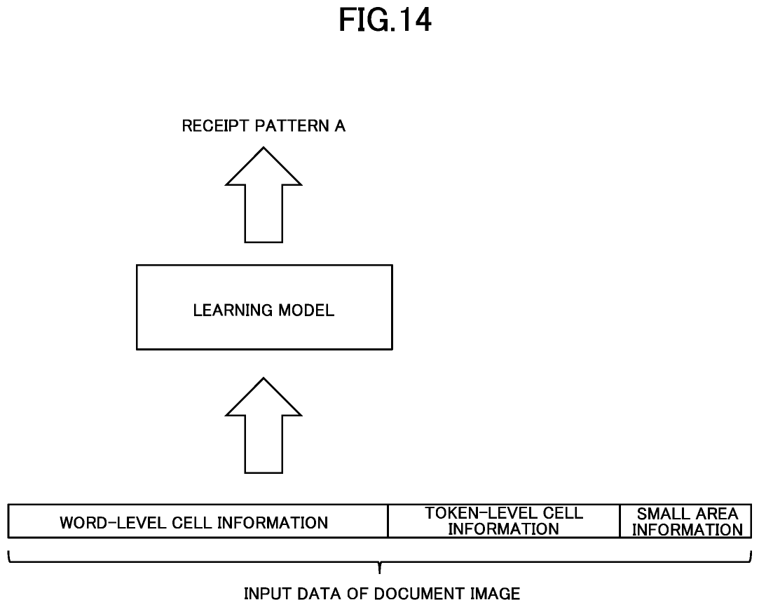

FIG. 14 is a diagram for illustrating an example of layout analysis in the second embodiment. For example, the layout analysis module 104 analyzes the layout by arranging the cell information on each of the plurality of scales under predetermined conditions, inputting the arranged cell information to the learning model, and acquiring the result of layout analysis by the learning model. In the second embodiment, similarly to the first embodiment, the layout analysis module 104 sorts the cell information by row, and then sorts the cell information by column. The layout analysis module 104 performs this sorting for each scale. The layout analysis module 104 acquires input data by arranging the cell information on each of the plurality of scales, and inputs the input data to the learning model. The learning model calculates a feature vector of time-series data, and outputs the layout corresponding to the feature vector.

For example, the layout analysis module 104 analyzes the layout by inputting, to the learning model, input data obtained by arranging a plurality of pieces of cell information on a first scale under a predetermined condition and then arranging a plurality of pieces of cell information on a second scale under a predetermined condition. In the example of FIG. 14, the layout analysis module 104 inputs, to the learning model, time-series data obtained by arranging token-level cell information, which is an example of the first scale, and then arranging word-level cell information, which is an example of the second scale. The first scale and the second scale are not limited to the example given in the second embodiment. For example, the layout analysis module 104 may input, to the learning model, time-series data obtained by arranging word-level cell information, which is an example of the first scale, and then arranging token-level cell information, which is an example of the second scale.

In the example of FIG. 14, of the whole input data, in the word-level cell information portion, the cell information on the word-level cells C201 to C232 is sorted by row, and then the cell information on the word-level cells C201 to C232 is sorted by column. Of the whole input data, in the token-level cell information portion, the cell information on the token-level cells C101 to C121 is sorted by row, and then the cell information on the token-level cells C101 to C121 is sorted by column. As described in the first embodiment, the sorting conditions are not limited to sorting by row and column. The cell information may be sorted based on another condition. After the sorting, the small area information on the small areas SA1 to SA9 is arranged.

In the second embodiment, the layout analysis module 104 arranges the cell information on each of the plurality of scales in order in input data in which the data size of each of the plurality of scales is defined such that when the scale size is smaller, the data size is larger, and inputs the thus-arranged input data to the learning model. In the example of FIG. 14, the word level has a smaller size than that of the token level, and hence the number of word-level cells C is likely to be larger than the number of token-level cells C. Thus, in the format of the time-series data, the word level has a larger data size than that of the token level. As used herein, “size” refers to the unit of the words detected as the cell C. When there are more words included in the cell C, the size is larger.

For example, when the total size of the cell information on each of the plurality of scales is less than a standard size determined for the input data for the learning model, the layout analysis module 104 adds padding to the input data to make up for the shortfall in the total size from the standard size, arranges the cell information on each of the plurality of scales in order in the padded input data, and inputs the thus-arranged input data to the learning model. In the example of FIG. 14, when the data size is insufficient for the word-level format, the layout analysis module 104 adds padding to make up for the shortfall. The padding is a predetermined character string indicating empty data. Through addition of padding, the input data has a predetermined size.

For example, the layout analysis module 104 analyzes the layout based on the cell information on each of the plurality of scales and the small area information on each of the plurality of small areas. In the example of FIG. 14, the layout analysis module 104 includes not only cell information but also small area information in the input data. In the example of FIG. 14, the small area information is arranged after the cell information, but the cell information may be arranged after the small area information. The learning model converts the input data into a feature amount, and outputs the layout corresponding to the feature amount. In the calculation of the feature amount, the arrangement of the cell information in the input data (connections between pieces of cell information and connections between pieces of small area information) is also taken into account.

Instead of arranging the token-level cell information after the word-level cell information in the input data, the word-level cell information and the token-level cell information may be arranged alternately. It suffices that the cell information on each of the plurality of scales be arranged in the input data based on a predetermined rule. When another machine learning method other than Vision Transformer is used, the layout analysis module 104 may input, to the learning model, input data including the cell information and the small area information as data in a format that can be input to a learning model of the another machine learning method.

### [Processing Execution Module]

The processing execution module 105 is the same as in the first embodiment.

### 2-1-2. Functions Implemented by User Terminal

The functions of the user terminal 20 are the same as those in the first embodiment.

### 2-2. Processing Executed in Second Embodiment

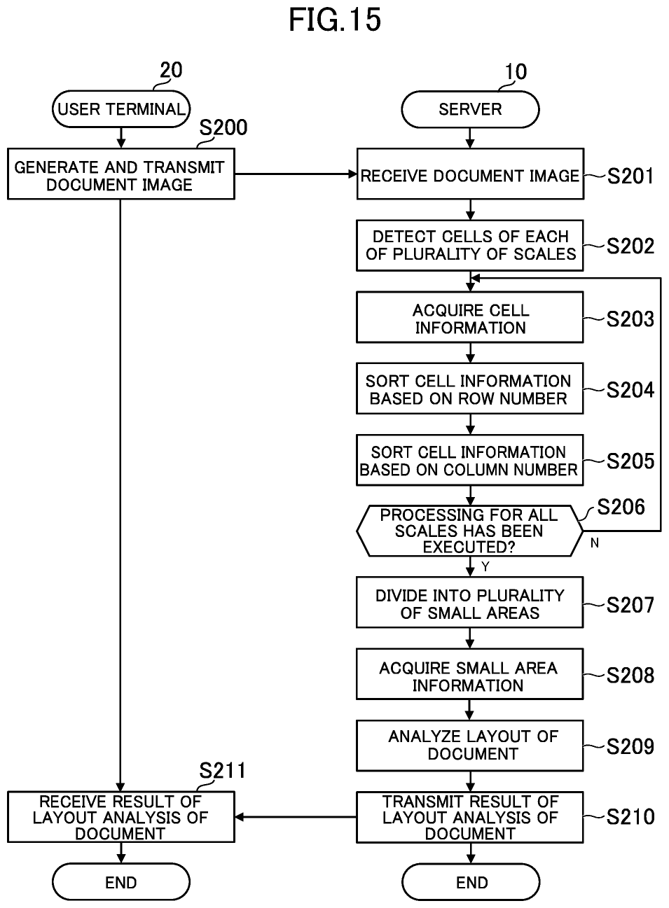

FIG. 15 is a flowchart for illustrating an example of processing executed in the second embodiment. The processing steps of Step S200 and Step S201 are the same as the processing steps of Step S100 and Step S101, respectively. The server 10 executes optical character recognition on the document image I, and detects the cells C of each of the plurality of scales (Step S202). The processing steps of Step S203 to Step S205 are the same as the processing steps of Step S103 to Step S105, respectively. The server 10 determines whether or not the processing for all scales has been executed (Step S206). When there is a scale for which processing has not been executed yet (“N” in Step S206), the processing steps of from Step S203 to Step S205 are executed.

When it is determined that the processing has been executed for all scales (“Y” in Step S206), the server 10 divides the document image I into a plurality of small areas SA (Step S207), and acquires the small area information (Step S208). The server 10 inputs, to the learning model, input data including the cell information on each of the plurality of scales and the small area information on each of the plurality of small areas SA, and analyzes the layout (Step S209). The subsequent processing steps of Step S210 and Step S211 are the same as the processing steps of Step S108 and Step S109, respectively.

The layout analysis system 1 of the second embodiment detects the cells C of each of the plurality of scales from in the document image I. The layout analysis system 1 acquires the cell information relating to the cells C of each of the plurality of scales. The layout analysis system 1 analyzes the layout of the document based on the cell information on each of the plurality of scales. As a result, the layout of the document D can be analyzed by taking the cells C of each of the plurality of scales into account in an integrated manner, thereby increasing the accuracy of the layout analysis.

Further, the layout analysis system 1 analyzes the layout based on a learning model which has learned for-training layouts relating to for-training documents. Through the use of a trained learning model, it becomes possible to handle unknown layouts.

Further, the layout analysis system 1 analyzes the layout by arranging the cell information on each of the plurality of scales under predetermined conditions, inputting the arranged cell information to the learning model, and acquiring the result of layout analysis by the learning model. Through the use of input data obtained by arranging the cell information, the layout can be analyzed by causing the learning model to take into account a relationship between pieces of cell information as well, thereby increasing the accuracy of the layout analysis. For example, the learning model can analyze the layout by also taking into account the relationship between the characteristics of a certain cell C and the characteristics of the next arranged cell C.

Further, in the layout analysis system 1, the learning model is a Vision Transformer-based model. Through the use of Vision Transformer which can easily take the relationships among the items included in the input data into account, it becomes easier to take the relationships among the pieces of cell information into account, and the accuracy of the layout analysis is thus increased.

Further, the layout analysis system 1 analyzes the layout by inputting, to the learning model, input data obtained by arranging a plurality of pieces of cell information on a first scale under a predetermined condition and then arranging a plurality of pieces of cell information on a second scale under a predetermined condition. As a result, the layout can be analyzed by causing the learning model to take the relationships among the cells C of a certain scale into account, thereby increasing the accuracy of the layout analysis.

Further, the layout analysis system 1 arranges the cell information on each of the plurality of scales in order in input data in which the data size of each of the plurality of scales is defined such that when the scale size is smaller, the data size is larger, and inputs the thus-arranged input data to the learning model. As a result, when the size of the scale is smaller, the number of cells C tends to be larger, and thus a situation in which the data size does not fit the format of the input data can be prevented.

Further, when the total size of the cell information on each of the plurality of scales is less than a standard size determined for the input data for the learning model, the layout analysis system 1 adds padding to the input data to make up for the shortfall in the total size from the standard size, arranges the cell information on each of the plurality of scales in order in the padded input data, and inputs the thus-arranged input data to the learning model. As a result, the input data can have a predetermined size, thereby increasing the accuracy of the layout analysis.

Further, the layout analysis system 1 acquires, from among the plurality of scales, the cell information on a scale in which a plurality of words is the unit of the cells C based on any one of the plurality of words. As a result, the layout analysis processing can be simplified.

Further, the layout analysis system 1 detects the cells C of each of the plurality of scales such that at least one of a plurality of components is included in a cell C having a different scale from the other cells C. As a result, a certain component can be analyzed from a plurality of viewpoints, thereby increasing the accuracy of the layout analysis.

Further, the layout analysis system 1 analyzes the layout based on the cell information on each of the plurality of scales and the small area information on each of the plurality of small areas SA. As a result, the layout can be analyzed by taking into account not only the plurality of scales but also other factors, thereby increasing the accuracy of the layout analysis.

Further, in the layout analysis system 1, the plurality of scales include a token level in which a token including a plurality of words is the unit of the cells C, and a word level in which a word is the unit of the cells C. As a result, the token level and the word level can be taken into account in an integrated manner, thereby increasing the accuracy of the layout analysis.

Further, the layout analysis system 1 detects the cells C by executing optical character recognition on the document image I. As a result, the accuracy of the layout analysis of the document D including characters is increased.

### 3. Modification Examples

The present disclosure is not limited to the first embodiment and the second embodiment described above, and can be modified suitably without departing from the spirit of the present disclosure.

### 3-1. Modification Examples Relating to First Embodiment

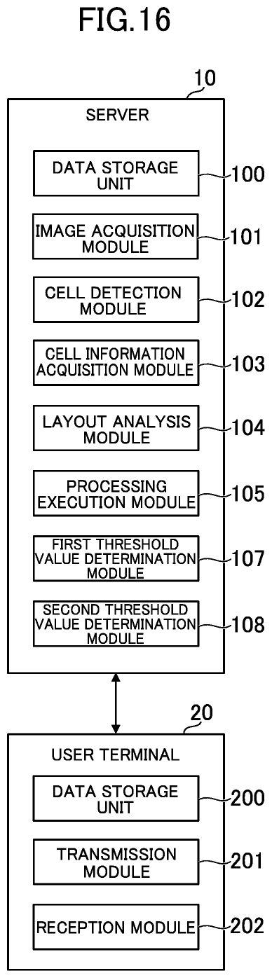

FIG. 16 is a diagram for illustrating an example of functions in modification examples relating to the first embodiment. In the modification examples relating to the first embodiment, the server 10 includes a first threshold value determination module 107 and a second threshold value determination module 108. The first threshold value determination module 107 and the second threshold value determination module 108 are implemented by the control unit 11.

### Modification Example 1-1

For example, in the first embodiment, description has been given of a case in which the threshold value for identifying the same rows and the threshold value for identifying the same columns are each a fixed value, but those threshold values may be determined based on the size of the whole document D. The layout analysis system 1 includes the first threshold value determination module 107. The first threshold value determination module 107 determines the threshold values based on the size of the whole document D. The size of the whole document D is at least one of the vertical length or the horizontal length of the whole document D. The area showing the whole document D in the document image I may be identified by contour detection processing. The first threshold value determination module 107 identifies the contour of the largest rectangle in the document image I as the area of the whole document D.

For example, the first threshold value determination module 107 determines the threshold values such that the threshold values become larger when the size of the whole document D is larger. The relationship between the size of the whole document D and the threshold value is recorded in advance in the data storage unit 100. This relationship is defined in data in a mathematical expression format, data in a table format, or a part of a program code. The first threshold value determination module 107 determines the threshold values such that the threshold values are associated with the size of the whole document D.

For example, the first threshold value determination module 107 determines the threshold values such that the threshold value for identifying the same rows becomes larger when the vertical length of the document D is longer. The first threshold value determination module 107 determines the threshold values such that the threshold value for identifying the same columns becomes larger when the horizontal length of the document D is longer. It suffices that the first threshold value determination module 107 determine at least one of the threshold value for identifying the same rows or the threshold values for identifying the same columns. Instead of determining both the threshold value for identifying the same rows and the threshold value for identifying the same columns, the first threshold value determination module 107 may determine only one of those threshold values.

The layout analysis system 1 of Modification Example 1-1 determines the threshold values based on the size of the whole document D. As a result, the optimal threshold values for identifying the rows and the columns can be set, thereby increasing the accuracy of the layout analysis.

### Modification Example 1-2

For example, the threshold values corresponding to the size of the cells C instead of the whole document D may be set. The layout analysis system 1 includes the second threshold value determination module 108. The second threshold value determination module 108 determines the threshold values based on the size of each of the plurality of cells. The size of the cells C is at least one of the vertical length or the horizontal length of the cells C. For example, the second threshold value determination module 108 determines the threshold values such that the threshold values become larger when the size of the cells C is larger.

For example, the relationship between the size of the cells C and the threshold value is recorded in advance in the data storage unit 100. This relationship is defined in data in a mathematical expression format, data in a table format, or a part of a program code. The second threshold value determination module 108 determines the threshold values such that the threshold values are associated with the size of the cells C.

For example, the second threshold value determination module 108 determines the threshold values such that the threshold value for identifying the same row as that of a certain cell C becomes larger when the vertical length of the certain cell C is longer. The second threshold value determination module 107 determines the threshold values such that the threshold value for identifying the same column as that of a certain cell C becomes larger when the vertical length of the certain cell C is longer. It suffices that the second threshold value determination module 108 determine at least one of the threshold value for identifying the same rows or the threshold value for identifying the same columns. Instead of determining both the threshold value for identifying the same rows and the threshold value for identifying the same columns, the second threshold value determination module 108 may determine only one of those threshold values.

The layout analysis system 1 of Modification Example 1-2 determines the threshold values based on the size of each of the plurality of cells C. As a result, the optimal threshold values for identifying the rows and the columns can be set, thereby increasing the accuracy of the layout analysis.

### Other Modification Examples Relating to First Embodiment

For example, in the first embodiment, as illustrated in FIG. 8, description has been given of a case in which input data obtained by arranging cell information sorted by row and then arranging cell information sorted by column is input to one learning model. However, a first learning model for analyzing the layout of the document D based on the cell information sorted by row and a second learning model for analyzing the layout of the document D based on the cell information sorted by column may be prepared separately.

For example, the first learning model has learned training data showing the relationship between input data in which the cell information on the cells detected from the training image is sorted by row and the layout of a for-training document shown in a training image. The layout analysis module 104 inputs, to the trained first learning model, input data in which the cell information on the cells C detected from the document image I is sorted by row. The first learning model converts the input data into a feature amount, and outputs the layout corresponding to the feature amount. The layout analysis module 104 analyzes the layout by acquiring the output from the first learning model.

For example, the second learning model has learned training data showing the relationship between input data in which the cell information on the cells detected from the training image is sorted by column and the layout of a for-training document shown in a training image. The layout analysis module 104 inputs, to the trained second learning model, input data in which the cell information on the cells C detected from the document image I is sorted by column. The second learning model converts the input data into a feature amount, and outputs the layout corresponding to the feature amount. The layout analysis module 104 analyzes the layout by acquiring the output from the second learning model.

For example, the layout analysis module 104 may analyze the layout based only on any one of the first learning model and the second learning model instead of analyzing the layout based on both the first learning model and the second learning model. That is, the layout analysis module 104 may analyze the layout of the document D based only on any one of the rows or the columns of the cells C detected from the document image I.

For example, in the first embodiment, description has been given of a case in which the layout of the document D is analyzed based on a learning model using a machine learning method, but the layout of the document D may be analyzed by using a method other than a machine learning method. For example, in the first embodiment, the layout of the document D may be analyzed by calculating a similarity between a pattern of an arrangement of at least one of the rows or the columns of the cells detected from a document image serving as a sample and a pattern of an arrangement of at least one of the rows or the columns of the cells C detected from the document image I.

### 3-2. Modification Examples Relating to Second Embodiment

For example, the layout analysis system 1 may include only the functions relating to the plurality of scales described in the second embodiment, and not include the functions relating to rows and columns described in the first embodiment. In the second embodiment, like the first embodiment, description has been given of a case in which the cell information is sorted by row and column, but in the second embodiment, the functions described in the first embodiment may not be included. Thus, in the second embodiment, the cell information on the cells C of each of the plurality of scales may be arranged in time-series data without sorting the cell information by row and column. In this case, it suffices that the cell information be sorted based on a condition other than by row and column. For example, in the second embodiment, it is not required to use the small area information in the layout analysis.

For example, in the second embodiment, description has been given of a case in which the layout of the document D is analyzed based on a learning model using a machine learning method, but the layout of the document D may be analyzed by using a method other than a machine learning method. For example, in the second embodiment, the layout of the document D may be analyzed by calculating a similarity between input data including the cell information on the cells C of each of a plurality of scales detected from the document image I and input data including the cell information on the cells of a plurality of scales detected from a document image serving as a sample.

### 3-3. Other Modification Examples

For example, the modification examples described above may be combined with one another.

For example, in the first embodiment and the second embodiment, description has been given of a case in which the main processing is executed by the server 10, but the processing described as being executed by the server 10 may be executed by the user terminal 20 or another computer, or may be distributed to a plurality of computers.

The invention claimed is:

1: A layout analysis system, comprising at least one processor configured to:
detect a cell of each of a plurality of scales from in a document image showing a document including a plurality of components;
acquire cell information relating to the cell of each of the plurality of scales; and
analyze a layout relating to the document based on the cell information on each of the plurality of scales.

2: The layout analysis system according to claim 1, wherein the at least one processor is configured to analyze the layout based on a learning model which has learned a for-training layout relating to a for-training document.

3: The layout analysis system according to claim 2, wherein the at least one processor is configured to analyze the layout by arranging the cell information on each of the plurality of scales under a predetermined condition, inputting the arranged cell information to the learning model, and acquiring a result of analysis of the layout by the learning model.

4: The layout analysis system according to claim 3, wherein the learning model is a Vision Transformer-based model.

5: The layout analysis system according to claim 3, wherein the at least one processor is configured to analyze the layout by inputting, to the learning model, input data obtained by arranging a plurality of pieces of cell information on a first scale under a predetermined condition and then arranging a plurality of pieces of cell information on a second scale under a predetermined condition.

6: The layout analysis system according to claim 3, wherein the at least one processor is configured to arrange the cell information on each of the plurality of scales in the order in input data in which a data size of each of the plurality of scales is defined such that when a scale size is smaller, the data size is larger, and to input the arranged input data to the learning model.

7: The layout analysis system according to claim 2, wherein when a total size of the cell information on each of the plurality of scales is less than a standard size determined for input data for the learning model, the at least one processor is configured to add padding to the input data to make up for a shortfall in the total size from the standard size, to arrange the cell information on each of the plurality of scales in the order in the padded input data, and to input the arranged input data to the learning model.

8: The layout analysis system according to claim 1, wherein the at least one processor is configured to acquire, from among the plurality of scales, the cell information on a scale in which a plurality of words is a unit of the cell based on any one of the plurality of words.

9: The layout analysis system according to claim 1, wherein the at least one processor is configured to detect the cell of each of the plurality of scales such that at least one of the plurality of components is included in a cell having a different scale from other cells.

10: The layout analysis system according to claim 1, wherein the at least one processor is configured to:
divide the document image into a plurality of small areas based on division positions determined in advance, and to acquire small area information relating to each of the plurality of small areas, and
analyze the layout based on the cell information on each of the plurality of scales and the small area information on each of the plurality of small areas.

11: The layout analysis system according to claim 1, wherein the plurality of scales include a token level in which a token including a plurality of words is a unit of the cell and a word level in which a word is a unit of the cell.

12: The layout analysis system according to claim 1, wherein the at least one processor is configured to detect the plurality of cells by executing optical character recognition on the document image.

13: A layout analysis method, comprising:
detecting a cell of each of a plurality of scales from in a document image showing a document including a plurality of components;
acquiring cell information relating to the cell of each of the plurality of scales; and
analyzing a layout relating to the document based on the cell information on each of the plurality of scales.

14: A non-transitory computer-readable information storage medium for storing a program for causing a computer to:
detect a cell of each of a plurality of scales from in a document image showing a document including a plurality of components;
acquire cell information relating to the cell of each of the plurality of scales; and
analyze a layout relating to the document based on the cell information on each of the plurality of scales.
